(19) United States
(12) Patent Application Publication
(10) Pub. No.: US 2016/0252101 A1
(43) Pub. Date: Sep. 1, 2016

(54) CENTRIFUGAL COMPRESSOR IMPELLER WITH BLADES HAVING AN S-SHAPED TRAILING EDGE

(71) Applicant: NUOVO PIGNONE SRL, Florence (IT)

(72) Inventors: Dante Tommaso RUBINO, Florence (IT); Satish VVNK KOYYALAMUDI, Bangalore, Karnataka (IN); Emanuele GUIDOTTI, Florence (IT)

(21) Appl. No.: 15/032,846

(22) PCT Filed: Oct. 27, 2014
(86) PCT No.: PCT/EP2014/072997

§ 371 Date: Apr. 28, 2016

(30) Foreign Application Priority Data
Oct. 28, 2013 (IT) FI2013A000261

(51) Int. Cl. F04D 29/28; F04D 29/44; F04D 17/10

(52) U.S. Cl. CPC F04D 29/284; F04D 17/10; F04D 29/444; F05D 2250/711; F05D 2250/712; F05D 2250/713

(57) ABSTRACT

The centrifugal compressor impeller comprises an inlet, an outlet and a disk extending from the inlet to the outlet. A plurality of blades extend from the disk, each blade having a leading edge at the inlet, a trailing edge at the outlet, a blade base extending along the disk between the leading edge and the trailing edge, and a blade tip extending between the leading edge and the trailing edge opposite the disk. The trailing edge is S-shaped with an intermediate inflection.

### BACKGROUND

The subject matter disclosed herein relates to improvements to compressors and more specifically to centrifugal compressors.

Centrifugal compressors convert mechanical energy provided by a prime mover, such as an electric motor, a gas turbine, a steam turbine or the like, into pressure energy for boosting the pressure of a gas flowing through the compressor. A compressor essentially comprises a casing rotatingly housing a rotor and a diaphragm bundle. The rotor can be comprised of one or more impellers, which are driven into rotation by the prime mover. The impellers are provided with blades having a broadly axial inlet section and a broadly radial outlet section. Flow channels are delimited by the blades and by a back plate or disc of the impeller. In some compressors, the impeller is provided with a shroud, opposite the back plate or disc, the blades extending between the back plate or disk and the shroud. Gas enters the flow channels of each impeller axially, is accelerated by the blades of the impeller and exit the impeller radially or in a mixed radial-axial fashion in the meridian plane. Accelerated gas is delivered by each impeller through a circumferentially arranged diffuser where the kinetic energy of the gas is at least partly converted in pressure energy, increasing the gas pressure.

The quantity of energy provided by the prime mover and absorbed by the compressor cannot be entirely converted into useful pressure energy, i.e. in pressure increment in the fluid, due to dissipation phenomena of various kinds involving the compressor as a whole. Some losses are caused by secondary vorticity, which is generated throughout the whole blade passage, cumulating near the trailing edges of the blades, at the outlet of the impeller.

### SUMMARY OF THE INVENTION

According to a first aspect, the present disclosure concerns a centrifugal compressor impeller, including an inlet, an outlet and a disk extending from the inlet to the outlet. A plurality of blades extends from the disk, each blade having a leading edge a trailing edge, a blade base and a blade tip. The blade base and blade tip extend between the leading edge and the trailing edge of the respective blade. Each blade further has a pressure side and a suction side. The trailing edge of each blade is S-shaped, such that on both the pressure side and the suction side the trailing edge has a concave trailing-edge portion and a convex trailing-edge portion, with an inflection point between the two trailing-edge portions.

The suction and pressure sides of each blade are thus defined by non-ruled surfaces, i.e. both sides of each blade have a three-dimensional curved shape. An improved compressor efficiency is achieved.

According to some embodiments the concave portion and the convex portion of the trailing edge of each blade are arranged so that a first portion of the trailing edge nearer the blade base has a convexity facing the pressure side of the blade and a second portion of the trailing edge, farther away from the blade base, has a convexity facing the suction side of the blade.

According to a further aspect, the present disclosure relates to a centrifugal compressor comprising at least one impeller as described above, and a diffuser arranged around the outlet of the impeller. In some embodiments, the compressor is a multi-stage compressor, wherein at least one and more particularly some or the totality of the impellers are designed as described above, with an S-shaped trailing edge.

According to yet a further aspect, the present disclosure relates to a method for designing a compressor impeller, comprising the following steps: defining a blade base profile along an impeller disk and a blade tip profile in a meridian plane; defining a pressure side surface and a suction side surface of the blade as ruled surfaces extending between the blade base profile and the blade tip profile, the pressure side surface and the suction side surface extending between a rectilinear trailing edge and a rectilinear leading edge of the blade; transforming the ruled surfaces into non-ruled surfaces by displacing points of the trailing edge along a tangential direction, thus imparting an S-shape to the trailing edge having a concave portion, a convex portion and an inflection point therebetween.

Features and embodiments are disclosed here below and are further set forth in the appended claims, which form an integral part of the present description. The above brief description sets forth features of the various embodiments of the present invention in order that the detailed description that follows may be better understood and in order that the present contributions to the art may be better appreciated. There are, of course, other features of the invention that will be described hereinafter and which will be set forth in the appended claims. In this respect, before explaining several embodiments of the invention in details, it is understood that the various embodiments of the invention are not limited in their application to the details of the construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which the disclosure is based, may readily be utilized as a basis for designing other structures, methods, and/or systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 illustrates a longitudinal section of a multi-stage centrifugal compressor, wherein impellers according to the present disclosure can be used;

FIG. 1A illustrates an enlargement of an impeller blade of the compressor of FIG. 1;

FIG. 2 illustrates a perspective view of an impeller of the centrifugal compressor of FIG. 1;

FIG. 3 illustrates a schematic diagram of a projection of a blade in a meridian plane;

FIG. 4 illustrates a diagram defining the metal angle of an impeller blade;

FIGS. 5 and 6 illustrate diagrams representing the blade thickness and the metal blade of the blade of FIG. 3 along the axial direction;

FIG. 7 illustrates a perspective view of a three-dimensional blade according to the present disclosure;

FIG. 8 illustrates a schematic view in a radial direction of a trailing edge of an impeller according to the present disclosure;

FIG. 9 illustrates a diagram of the polythropic efficiency versus flow coefficient of an impeller of the current art and of an impeller according to the present disclosure.

### DETAILED DESCRIPTION

The following detailed description of the exemplary embodiments refers to the accompanying drawings. The same reference numbers in different drawings identify the same or similar elements. Additionally, the drawings are not necessarily drawn to scale. Also, the following detailed description does not limit the invention. Instead, the scope of the invention is defined by the appended claims.

Reference throughout the specification to “one embodiment” or “an embodiment” or “some embodiments” means that the particular feature, structure or characteristic described in connection with an embodiment is included in at least one embodiment of the subject matter disclosed. Thus, the appearance of the phrase “in one embodiment” or “in an embodiment” or “in some embodiments” in various places throughout the specification is not necessarily referring to the same embodiment(s). Further, the particular features, structures or characteristics may be combined in any suitable manner in one or more embodiments.

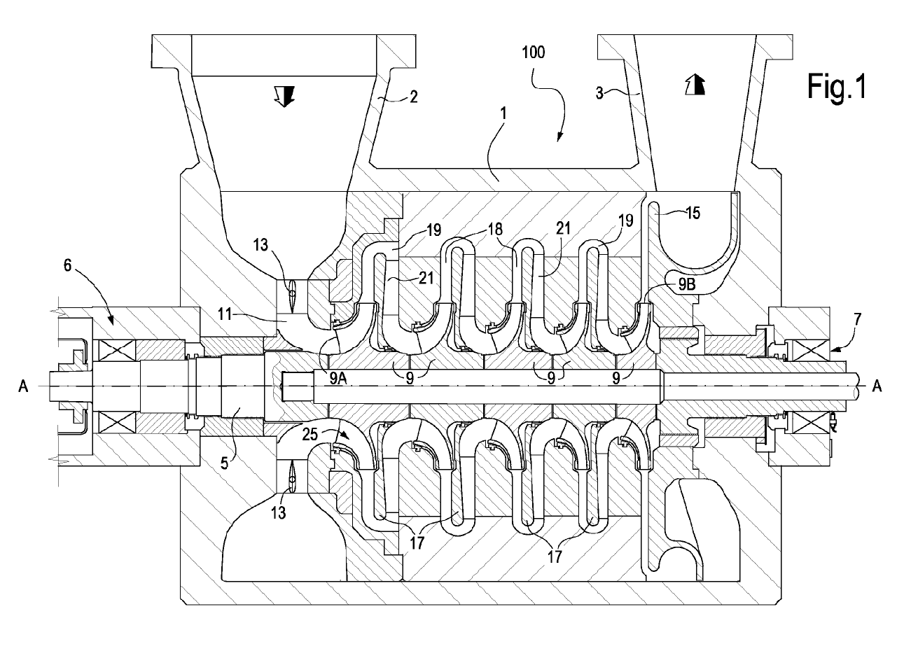

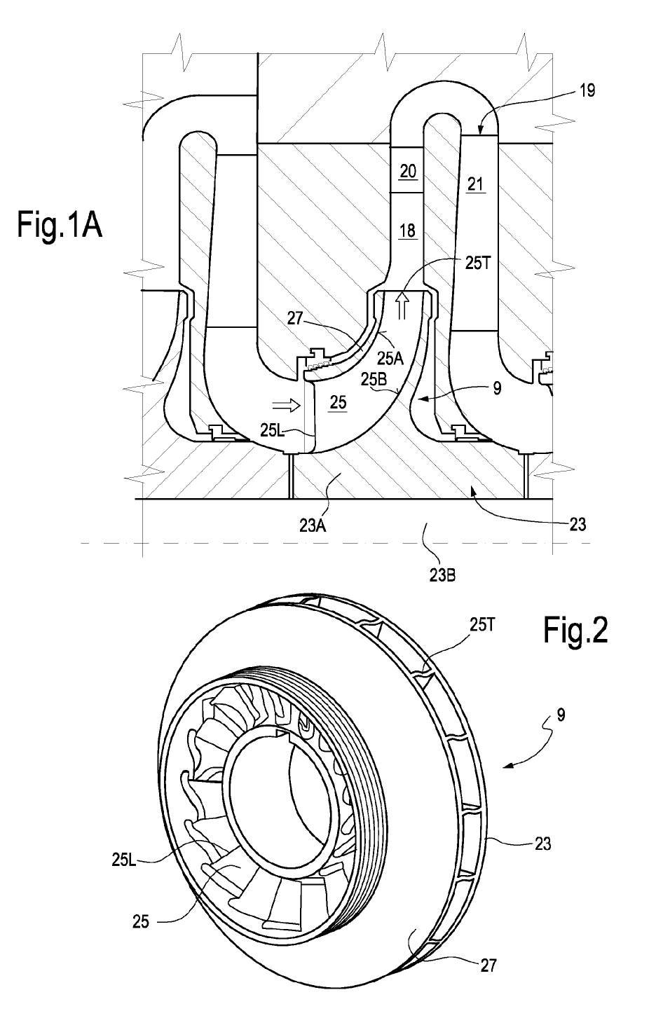

FIGS. 1 and 1A illustrate an exemplary embodiment of a multistage centrifugal compressor, globally labeled 100, wherein the subject matter disclosed herein can be embodied. FIG. 1 illustrates a sectional view according to a plane containing a rotation axis A-A of the compressor and FIG. 1A illustrates an enlargement of one compressor stage.

The compressor 100 has an outer casing 1 provided with an inlet manifold 2 and an outlet manifold 3. Inside the casing 1 several components are arranged, which define a plurality of compressor stages.

More specifically, the casing 1 houses a compressor rotor. The compressor rotor is comprised of a rotor shaft 5. The rotor shaft 5 can be supported by two end bearings 6, 7. The compressor rotor further comprises at least one impeller. In some embodiments, as shown in FIG. 1, the compressor rotor comprises a plurality of impellers 9, one impeller for each compressor stage. The impellers 9 are arranged between the two bearings 6, 7.

The inlet 9A of the first impeller 9 is in fluid communication with an inlet plenum 11, wherein gas to be compressed is delivered through the inlet manifold 2. In some embodiments, the gas flow enters the inlet plenum 11 radially and is then delivered through a set of movable inlet guide vanes 13 and enters the first impeller 9 in a substantially axial direction.

According to the exemplary embodiment of FIG. 1, the outlet 9B of the last impeller 9 is in fluid communication with a volute 15, which collects the compressed gas and delivers it towards the outlet manifold 3.

Stationary diaphragms 17 are arranged between each pair of sequentially arranged impellers 9. Diaphragms 17 can be formed as separate, axially arranged components. In other embodiments, the diaphragms 17 can be formed in two substantially symmetrical halves. Each diaphragm 17 defines a diffuser 18 and a return channel 19, which extend from the radial outlet of the respective upstream impeller 9 to the inlet of the respective downstream impeller 9. In the diffuser 18 the gas flow is slowed and kinetic energy transferred from the impeller to the gas is converted into pressure energy, thus increasing the gas pressure.

The return channel 19 returns the compressed gaseous flow from the outlet of the upstream impeller towards the inlet of the downstream impeller. In some embodiments, fixed blades 20 can be arranged in the diffuser 18. In some embodiments, fixed blades 21 can be provided in the return channels 19, for removing the tangential component of the flow while redirecting the compressed gas from the upstream impeller to the downstream impeller.

As best shown in FIG. 1A, where an enlargement of one of the several compressor stages of compressor 100 is shown, and in FIG. 2, where an exemplary impeller is illustrated in an axonometric view, each impeller 9 is comprised of a disc 23 defining a hub portion 23A. The hub portion 23A has a bore 23B, through which the rotor shaft 5 extends. The disc 23 is sometimes also named hub as a whole. A plurality of blades 25 extend from the disc 23 and define flow channels, through which the gas flows and is accelerated by the blades 25. Each blade has a leading edge 25L and a trailing edge 25T arranged respectively at the inlet and at the outlet of the blade. In some embodiments, the impeller 9 can be open. In other embodiments the impeller can be closed by a shroud 27, arranged opposite the disc 23, the blades 25 extending between disc 23 and shroud 27.

Each blade 25 is provided with a blade tip 25A extending along the shroud 27, between the leading edge 25L and the trailing edge 25T. Each blade 25 is further provided with a blade base or blade root 25B extending along the disc 23 between the leading edge 25L and the trailing edge 25T.

Each blade 25 has a suction side and a pressure side and the shape of the blade is defined in the manner described here below, starting from the intersection of the centerline or camber line of the blade 25 with the disc 23 and shroud 27, respectively. FIG. 3 shows a projection of a generic blade 25 in a meridian plane, i.e. the plane R-Z, where R is the radial direction and Z is the axial direction. L1 is the projection on the meridian plane R-Z of the center line, i.e. camber line of the blade profile at the disc 23. L2 is the projection on the same meridian plane R-Z of the center line, i.e. camber line of the blade profile, at the shroud 27.

The lines L1 and L2 are therefore the projections of the blade profiles in the R-Z plane (meridian plane) at disk and shroud, i.e. at the blade base and blade tip, respectively. In FIG. 3 the projection of the trailing edge 25T and of the leading edge 25L of the blade are also represented.

As noted above, the impeller 9 can be shrouded as shown in the exemplary embodiment illustrated in the drawings. However, in other embodiments, not shown, the impeller 9 is open and the shroud 27 is not provided. In this case line L2 is simply the projection of the camber line or center line at the blade tip 25A on the meridian plane R-Z.

These lines L1 and L2 are the starting points for designing the three-dimensional surfaces of the suction side and pressure side of the blade, as follows.

Starting from the two lines L1 and L2, the actual shape of the opposite surfaces of the blade 25, defining the suction side and the pressure side of the blade are determined by means of two additional parameters, namely the blade thickness and the blade metal angle. Both parameters are defined for a plurality of positions along each line L1 and L2. In some embodiments, blade metal angle and blade thickness can have different values for line L1 and line L2.

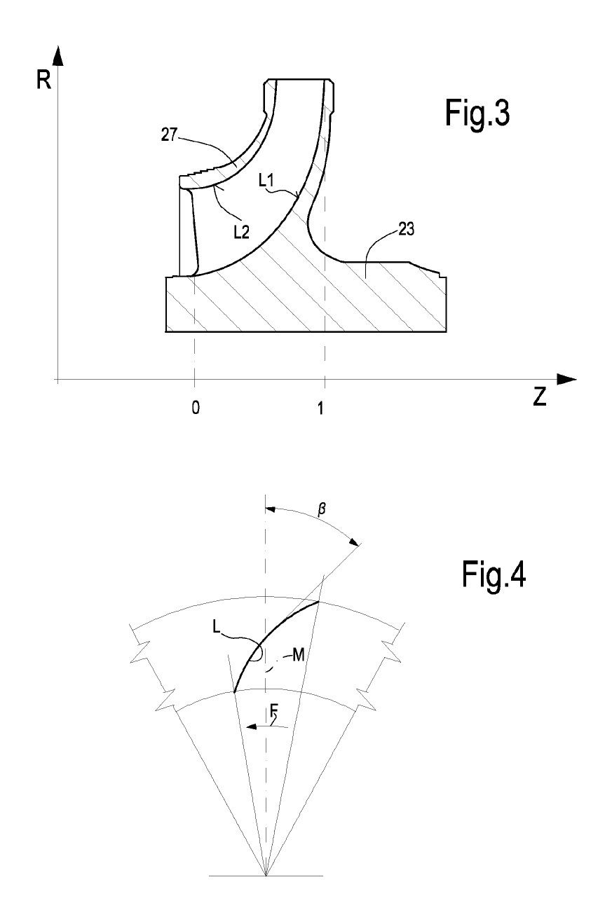

The blade metal angle β in each point of line L1 or L2 considered is defined as the angle between the tangent to the line L1 or L2 and the meridian direction (M), as shown in FIG. 4, which illustrates a schematic front view of the impeller, and L is the generic centerline considered. Arrow F indicates the direction of rotation of the impeller. Conventionally, the sign of the angle β is concordant with the direction of rotation of the impeller. Thus, in the example of FIG. 4 the angle β is negative, as it is measured starting from the meridian direction M and is opposite the direction of rotation of the impeller (arrow F).

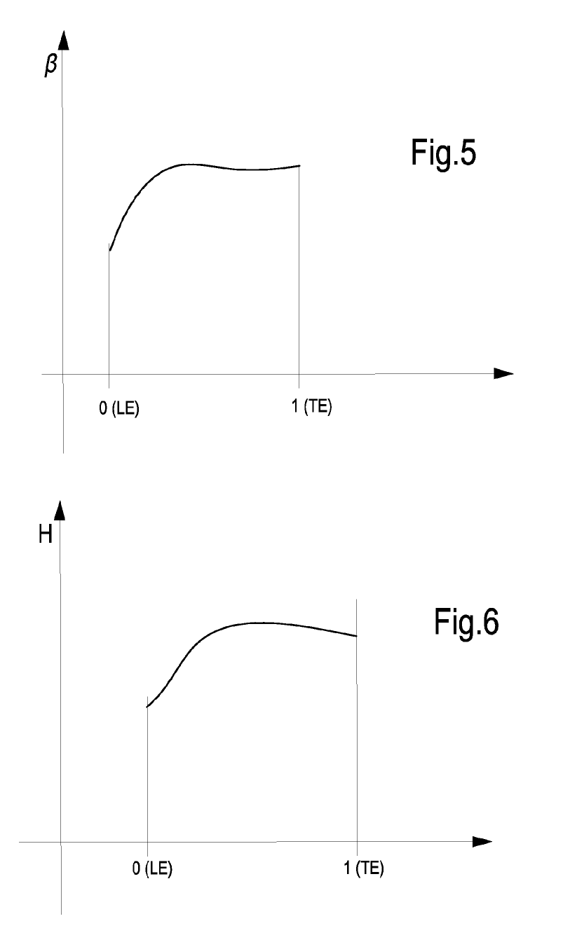

The thickness (th) of the blade is defined as the distance between the suction side surface and the pressure side surface of the blade from the camber line (i.e. the central line) of the blade at each point of the curve L1 or L2 considered. FIGS. 5 and 6 illustrate schematically the distribution of the metal angle (β) and the thickness (th) for an exemplary blade. On the horizontal axis of the diagrams of FIGS. 5 and 6 the normalized coordinate along the meridian direction is shown. Coordinate “0” indicates the position at the leading edge and coordinate “1” indicates the position at the trailing edge of the blade.

The combination of the above defined parameters gives the profile of the blade at the blade tip 25A and at the blade base 25B. The next step for defining the surface of the pressure side and suction side of the blade is now the generation of two opposite ruled surfaces starting from the two blade profiles at the blade tip 25A and blade base 25B as defined above. The ruled surfaces are generated by connecting each point of the blade tip profile with a corresponding point of the blade base profile with a rectilinear (straight) line.

The geometry of the blade is not yet completely defined, as the curves L1 and L2 and the corresponding blade tip and blade base profiles are usually shifted, i.e. displaced one with respect to the other, in the tangential direction, rotating the blade tip profile and blade base profile one with respect to the other around the rotation axis of the impeller. A further degree of freedom is therefore available for the full definition of the blade geometry, given by the possible tangential displacement of the two curves L1 and L2. In the impellers of the current art, the two curves L1 and L2 are tangentially shifted, i.e. rotated one with respect to the other around the impeller axis, thus inclining the trailing edge 25T with respect to the axial direction (for an impeller with purely radial exit) maintaining its rectilinear (straight) shape. The inclination of the trailing edge with respect to the axial direction, named angle of lean, defines, along with the above mentioned parameters, the entire geometry of the blade.

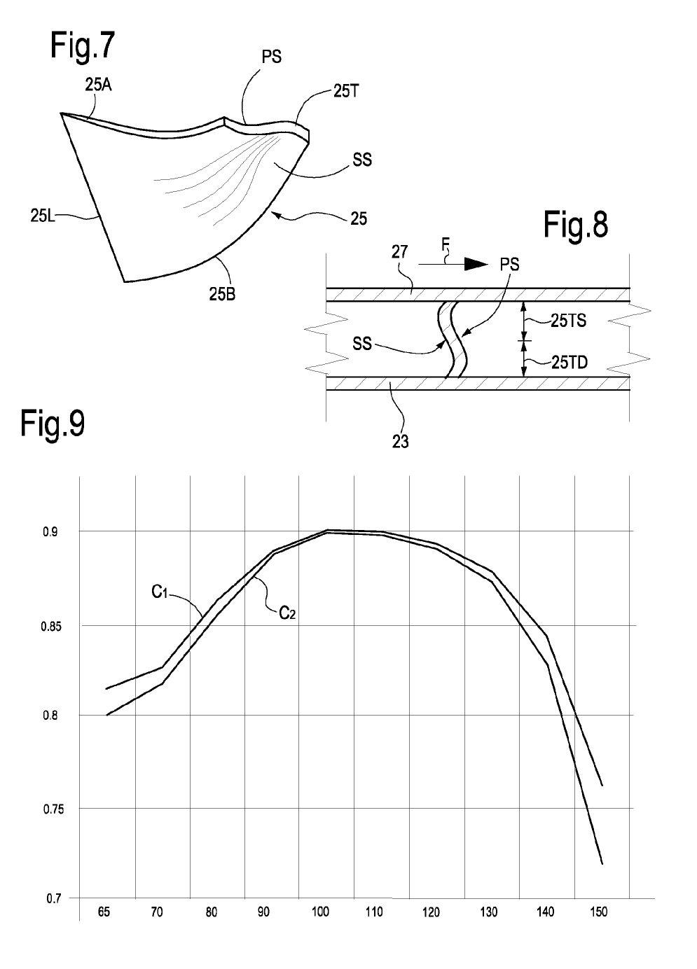

Conversely, according to the subject matter disclosed herein, the blade tip profile and blade base profile and the intermediate profiles between blade tip and blade base are displaced in the tangential direction so that the trailing edge 25T becomes non-rectilinear and more specifically takes an S-profile, as shown in FIG. 7 in a perspective view and in FIG. 8 in a side view. More specifically, FIG. 7 illustrates a single blade 25 in a perspective view with the trailing edge 25T facing the viewer.

The trailing edge 25T has a first portion 25TD and a second portion 25Ts. The first portion 25TD is located nearer the disc 23 and the second portion 25Ts is located nearer the shroud 27 (see in particular FIG. 8).

In some exemplary embodiments, the first portion 25TD of the trailing edge nearer the disc 23 has a convexity facing the pressure side PS of the blade and a concavity facing the suction side SS of the blade. The pressure side PS of the blade is the leading side with respect to the direction of rotation F and the suction side SS of the blade is the trailing side with respect to the direction of rotation F, i.e. the side opposite the pressure side. The second portion 25Ts of the trailing edge 25T has an opposite arrangement: the pressure side is concave and the suction side is convex.

A reverse arrangement is not excluded, wherein the convexity is facing the suction side near the disc and the pressure side near the shroud.

In some embodiments the first portion and the second portion of the trailing edge merge one with the other in an inflection point, so that the entire trailing edge is curve and devoid of rectilinear portions.

The S-shaped configuration of the trailing edge is obtained by providing a suitable rule for displacing each point of the trailing edge in the tangential direction, i.e. around the rotation axis of the impeller. In actual fact, the shape of the trailing edge can be obtained, e.g. starting from the blade base profile (or from the blade tip profile), tangentially shifting a plurality of points along the trailing edge and connecting the points by interpolation. The displacement of the various points of the trailing edge in the tangential direction causes a rigid displacement of the remaining points of the pressure side surface and suction side surface previously generated as ruled surfaces starting from the blade base profile and blade tip profile obtained from lines L1, L2 and the blade thickness and metal angle distribution there along.

As a final result, the entire surfaces of both the pressure side and the suction side of the impeller will become non-ruled surfaces having a double curvature.

The double, S-shaped curvature of the trailing edge 25T of the blade reduces the losses improving the polytropic efficiency of the compressor. This can be appreciated from FIG. 9, illustrating the polytropic efficiency versus the flow coefficient of a compressor stage using an impeller having an S-shaped trailing edge (curve C1), and of a compressor stage using an impeller having a rectilinear trailing edge (curve C2). In off-design conditions (flow coefficient lower or higher than 100), the polytropic efficiency of the impeller having S-shaped trailing edges 25T is remarkably improved over the current art design with rectilinear trailing edges.

While the disclosed embodiments of the subject matter described herein have been shown in the drawings and fully described above with particularity and detail in connection with several exemplary embodiments, it will be apparent to those of ordinary skill in the art that many modifications, changes, and omissions are possible without materially departing from the novel teachings, the principles and concepts set forth herein, and advantages of the subject matter recited in the appended claims. Hence, the proper scope of the disclosed innovations should be determined only by the broadest interpretation of the appended claims so as to encompass all such modifications, changes, and omissions. Different features, structures and instrumentalities of the various embodiments can be differently combined.

What is claimed is:

1. A centrifugal compressor impeller, the impeller comprising:
an inlet;
an outlet;
a disk extending from the inlet to the outlet; and
a plurality of blades extending from the disk, each blade being comprised of: a leading edge at the inlet; a trailing edge at the outlet; a blade base extending along the disk, between the leading edge and the trailing edge; a blade tip opposite the disk, extending between the leading edge and the trailing edge; a pressure side; and a suction side;
wherein the trailing edge is S-shaped, having a concave portion, a convex portion and an inflection point therebetween.

2. The impeller of claim 1, wherein the concave portion and the convex portion of the trailing edge are arranged so that a first portion of the trailing edge nearer the blade base has a convexity facing the pressure side of the blade and a second portion of the trailing edge, farther away from the blade base, has a convexity facing the suction side of the blade.

3. The impeller of claim 1, wherein the trailing edge is entirely curved along the full extension thereof, between the blade base and the blade tip, and is devoid of any rectilinear section.

4. The impeller of claim 1, wherein each blade is entirely curved according to a double curvature on both the pressure side and the suction side and is free of ruled surfaces.

5. A centrifugal compressor, the centrifugal compressor comprising
at least one impeller, the impeller comprising:
an inlet;
an outlet;
a disk extending from the inlet to the outlet; and
a plurality of blades extending from the disk, each blade being comprised of: a leading edge at the inlet a trailing edge at the outlet a blade base extending along the disk, between the leading edge and the trailing edge; a blade tip opposite the disk, extending between the leading edge and the trailing edge; a pressure side; and a suction side and
a diffuser arranged around the outlet of the impeller,
wherein the trailing edge is S-shaped, having a concave portion, a convex portion and an inflection point therebetween.

6. A method for designing a compressor impeller, the method comprising:
defining a blade base profile along an impeller disk and a blade tip profile in a meridian plane;
defining a pressure side surface and a suction side surface of the blade as ruled surfaces extending between the blade base profile and the blade tip profile, the pressure side surface and the suction side surface extending between a rectilinear trailing edge and a rectilinear leading edge of the blade; and
transforming the ruled surfaces into non-ruled surfaces by displacing points of the trailing edge along a tangential direction, thus imparting an S-shape to the trailing edge having a concave portion, a convex portion and an inflection point therebetween.

7. The method of claim 6, wherein the concave portion and the convex portion of the trailing edge are arranged so that a first portion of the trailing edge nearer a blade base has a convexity facing the pressure side of the blade and a second portion of the trailing edge, farther away from the blade base, has a convexity facing the suction side of the blade.

8. The impeller of claim 2, wherein the trailing edge is entirely curved along the full extension thereof, between the blade base and the blade tip, and is devoid of any rectilinear section.

9. The impeller of claim 2, wherein each blade is entirely curved according to a double curvature on both the pressure side and the suction side and is free of ruled surfaces.

10. The impeller of claim 3, wherein each blade is entirely curved according to a double curvature on both the pressure side and the suction side and is free of ruled surfaces.

11. The centrifugal compressor of claim 5, wherein the concave portion and the convex portion of the trailing edge are arranged so that a first portion of the trailing edge nearer the blade base has a convexity facing the pressure side of the blade and a second portion of the trailing edge, farther away from the blade base, has a convexity facing the suction side of the blade.

12. The centrifugal compressor of claim 5, wherein the trailing edge is entirely curved along the full extension thereof, between the blade base and the blade tip, and is devoid of any rectilinear section.

13. The centrifugal compressor of claim 5, wherein each blade is entirely curved according to a double curvature on both the pressure side and the suction side and is free of ruled surfaces.

14. The centrifugal compressor of claim 5, wherein the concave portion and the convex portion of the trailing edge are arranged so that a first portion of the trailing edge nearer the blade base has a convexity facing the pressure side of the blade and a second portion of the trailing edge, farther away from the blade base, has a convexity facing the suction side of the blade.

15. The centrifugal compressor of claim 5, wherein the trailing edge is entirely curved along the full extension thereof, between the blade base and the blade tip, and is devoid of any rectilinear section.

16. The centrifugal compressor of claim 5, wherein each blade is entirely curved according to a double curvature on both the pressure side and the suction side and is free of ruled surfaces.
